(19) United States
(12) Patent Application Publication
(10) Pub. No.: US 2007/0017720 A1
(43) Pub. Date: Jan. 25, 2007

(54) Battery device of vehicle power supply

(76) Inventors: Kazuhiro Fujii, Taka-gun (JP); Ryosaku Izawa, Higashiosaka-city (JP); Koichi Aoishi, Kasai-city (JP)

Correspondence Address: WENDEROTH, LIND & PONACK, L.L.P., 2033 K STREET N. W., SUITE 800, WASHINGTON, DC, 20006-1021, US

(21) Appl. No.: 11/187,932

(22) Filed: Jul. 25, 2005

(51) Int. Cl. B60R 16/04

(52) U.S. Cl. 180/68.5

(57) ABSTRACT

A power device for a vehicle includes a base portion to be mounted on the vehicle, a resin component having a through hole which is to be fixed to the base portion, a metal sleeve inserted through an internal surface of the through hole of the resin component and having a flange on an opposed surface to the base portion, and a metal screw inserted through the metal sleeve inserted in the through hole of the resin component, thereby fixing the resin component to the base portion through the metal sleeve. The base portion has a female screw member into which a tip portion of the metal screw is to be screwed and has a support member provided on an opposed surface to the metal sleeve. In the power device, the metal screw is inserted through the metal sleeve to screw a screw portion on a tip into the female screw member and fixes the metal sleeve to the base portion, thereby securing the resin component to the base portion.

### BACKGROUND OF THE INVENTION

1. Field of the Invention

The present invention relates to a power device to be mounted on a vehicle such as an automobile, and more particularly to a power device in which a resin component is fixed to a base portion with a screw so as not to be loosened.

2. Description of the Related Art

A power device to be mounted on an automobile has a built-in battery for driving a motor to cause the automobile to run. The power device is fixed to a vehicle with a screw and a nut to be removable and attachable in order to maintain the built-in battery and electronic equipment. The power device can be decomposed by removing the screw when the maintenance is to be carried out. When the battery breaks down, particularly, the battery is to be exchanged. For this reason, it is necessary to employ a structure in which a holder case accommodating the batter can be decomposed. Moreover, the power device to be mounted on the vehicle is to have a weight which is as small as possible. Therefore, a resin component formed of plastic which has a smaller weight than a metal is used. However, there is a drawback that the screw is apt to be loosened with the passage of time if the resin component is fastened and fixed with the screw. In the automobile, particularly, a temperature is changed sharply and a strong vibration is caused. Therefore, the screw is loosened easily. FIG. 1 shows a state in which a screw 23 fixing a resin component 22 to a base portion 21 is loosened. In FIG. 1, at first, the screw 23 is completely fastened. However, the resin component 22 expands and contracts and thus becomes thin by the repetition of a low temperature and a high temperature and a vibration so that a clearance is formed between a screw head 23A and the resin component 22 and the screw is loosened easily. When the automobile further runs to receive the vibration in this condition, the screw 23 is loosened still more.

In order to prevent the screw or the nut from being loosened, there is employed a lock structure for inserting a split pin through a head portion of a screw or a nut. Referring to the screw and the nut in this structure, however, the split pin is removed when they are to be loosened, and is set when they are to be fixed. For this reason, there is a drawback that a great deal of time and labor is required for the removal and attachment. For this reason, particularly, this structure is used for a very important portion of an automobile, for example, a suspension, a handle link or the like. In order to easily remove or attach the screw or the nut, lock nuts having various structures have been developed (see Japanese Unexamined Patent Publication (KOKAI) No. 7-151129).

### SUMMARY OF THE INVENTION

As described in the publication, similarly, a lock nut having a locking structure has a whole complicated structure. For this reason, a manufacturing cost is increased more greatly as compared with an ordinary screw or nut. Moreover, a plurality of parts is used in determined order to carry out fastening. Therefore, there is also a drawback that a great deal of time and labor is required for fastening and removal.

In the power device for a vehicle, furthermore, even if the lock nut having the locking structure is used to carry out fastening without a looseness, a clearance is formed when a resin component becomes thin due to a vibration or a change in a temperature. The clearance causes a vibration or a noise to damage an electronic component and a battery, and furthermore, an uncomfortable noise is made in the automobile.

The present invention has been developed in order to solve the aforementioned drawbacks. An important object of the present invention is to provide a power device for a vehicle which can effectively prevent a fastening portion from being loosened due to a change in a temperature and can firmly fix a resin component to a base portion with a very simple structure.

A power device for a vehicle according to the present invention comprises a base portion 1 to be mounted on the vehicle, a resin component 2 having a through hole 5 which is to be fixed to the base portion 1, a metal sleeve 4 inserted through an internal surface of the through hole 5 of the resin component 2 and having a flange 4A on an opposed surface to the base portion 1, and a metal screw 3 inserted through the metal sleeve 4 inserted in the through hole 5 of the resin component 2, thereby fixing the resin component 2 to the base portion 1 through the metal sleeve 4. The base portion 1 has a female screw member 6 into which a tip portion of the metal screw 3 is to be screwed and has a support member 13 provided on an opposed surface to the metal sleeve 4. In the power device, the metal screw 3 is inserted through the metal sleeve 4 to screw a screw portion 3B on a tip into the female screw member 6 and fixes the metal sleeve 4 to the base portion 1, thereby securing the resin component 2 to the base portion 1.

The power device described above has such a feature that the metal screw can be effectively prevented from being loosened due to a change in a temperature and the resin component can be firmly fixed to the base portion with a very simple structure. The reason is that the metal sleeve having the flange is inserted in the through hole of the resin component and the metal screw is inserted through the metal sleeve to hold the metal sleeve, thereby fixing the resin component to the base portion. The thermal expansion of a metal is smaller than that of a synthetic resin, and the thermal expansion of the metal sleeve is smaller than that of the resin component. For this reason, the amount of deformation caused by a change in the temperature of the metal sleeve is smaller than that of the resin component. Even if the resin component repeats a thermal expansion and a thermal contraction due to the change in the temperature, the thermal expansion of the metal sleeve is small and the metal sleeve is firmly held and fixed between the metal screw and the base portion. According to the present invention, therefore, it is possible to effectively prevent the metal screw from being loosened due to a change in a temperature and to firmly fix the resin component to the base portion.

Furthermore, the power device described above is provided with the flange on the opposed surface to the base portion of the metal sleeve, and the resin component is fixed to the base portion with the metal screw in a state in which the flange is caused to abut on the support member of the base portion. The flange of the metal sleeve comes in contact with the support member in a large area. For this reason, the support member presses, holds and fixes the metal sleeve at a uniform pressure. Therefore, the metal sleeve is held by the support member so that an imbalanced pressing force does not locally act thereon, and the metal sleeve can be prevented from taking an unnatural posture, the position of the metal sleeve can be prevented from being shifted, and the metal sleeve and the resin component can be interposed between the support member and the metal screw in an ideal condition and can be thus fixed to the base portion.

In the power device for a vehicle according to the present invention, the base portion 1 can include the female screw member 6 and a base plate 11 fixing the female screw member 6, and the female screw member 5 can be secured to the base plate 11 through a rubber-like elastic member 7.

In the power device for a vehicle according to the present invention, the base portion 1 can include a rubber nut 9 fixing a metallic outer casing 8 to an outside of the female screw member 6 through the rubber-like elastic member 7, and a screw cylinder 12 fixed to the base plate 11 by ring welding, thereby securing the rubber nut 9. In the power device, the rubber nut 9 can have a male screw provided on an outer periphery of the metallic outer casing 8, the screw cylinder 12 can have a female screw provided on an inner peripheral surface, and the male screw of the rubber nut 9 can be screwed into the female screw of the screw cylinder 12, thereby coupling the rubber nut 9 to the base plate 11.

In the power device for a vehicle according to the present invention, the resin component 2 can be set to be a holder case 10 for a battery which accommodates a plurality of batteries therein.

In the power device for a vehicle according to the present invention, an overall length of the metal sleeve 4 can be set to be almost equal to a length of the through hole 5 having the metal sleeve 4 provided therein, and the metal screw 3 can hold both the metal sleeve 4 and the resin component 2 and can fix them to the base portion 1.

In the power device for a vehicle according to the present invention, a hard ring 13A can be provided between the metal sleeve 4 and the base portion 1 and can be caused to abut on the flange 4A.

In the power device for a vehicle according to the present invention, the holder case 10 can be accommodated in the outer case 14, and the outer case 14 can be interposed between a hard ring 13A inserted through the metal screw 3 and the rubber nut 9 and can be fixed to the base portion 1.

In the power device for a vehicle according to the present invention, furthermore, a foreign matter invasion blocking wall 18 can be protruded from an internal surface of the outer case 14, and the holder case 10 can be accommodated in the foreign matter invasion blocking wall 18 to prevent an invasion of a foreign matter by means of the foreign matter invasion blocking wall 18.

The above and further objects and features of the invention will be more fully apparent from the following detailed description with accompanying drawings.

### BRIEF DESCRIPTION OF THE DRAWINGS

FIG. 1 is a sectional view showing a principle in which a screw for fixing a resin component to a base portion is loosened;

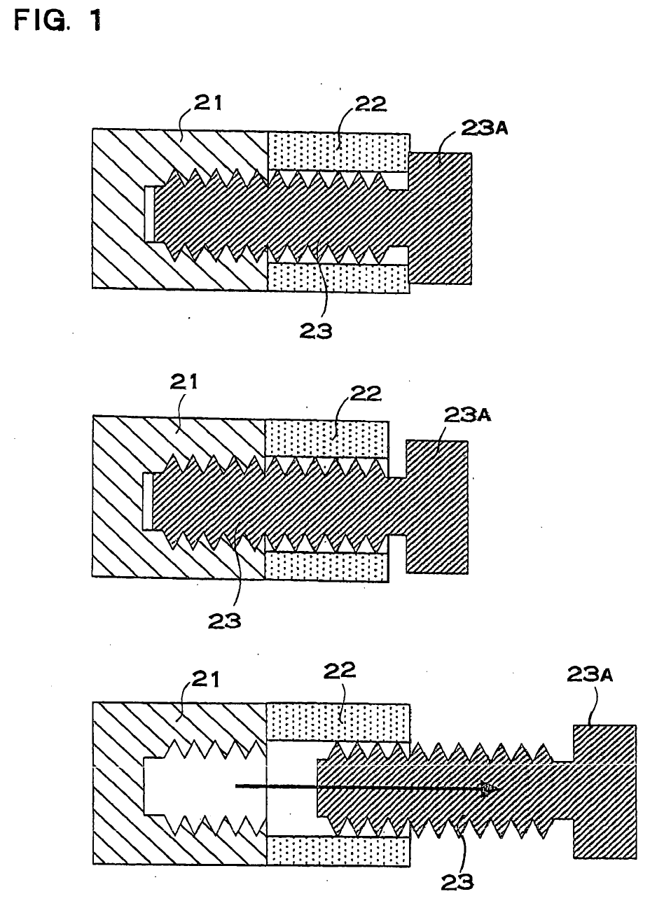

FIG. 2 is a plan view showing an internal structure of a power device for a vehicle according to an embodiment of the present invention;

FIG. 3 is a longitudinal sectional view showing the power device for a vehicle according to the embodiment of the present invention, corresponding to a section taken along an A-A line in FIG. 1;

FIG. 4 is an end view taken along a B-B line in the power device for a vehicle illustrated in FIG. 2;

FIG. 5 is an enlarged sectional view showing a coupling structure of a metal screw and a base portion in the power device for a vehicle illustrated in FIG. 3;

FIG. 6 is an enlarged sectional view showing a screw head portion of the metal screw in the power device for a vehicle illustrated in FIG. 3; and

FIG. 7 is an enlarged view showing main parts of the power device for a vehicle illustrated in FIG. 4.

### DETAILED DESCRIPTION OF THE PREFERRED EMBODIMENTS

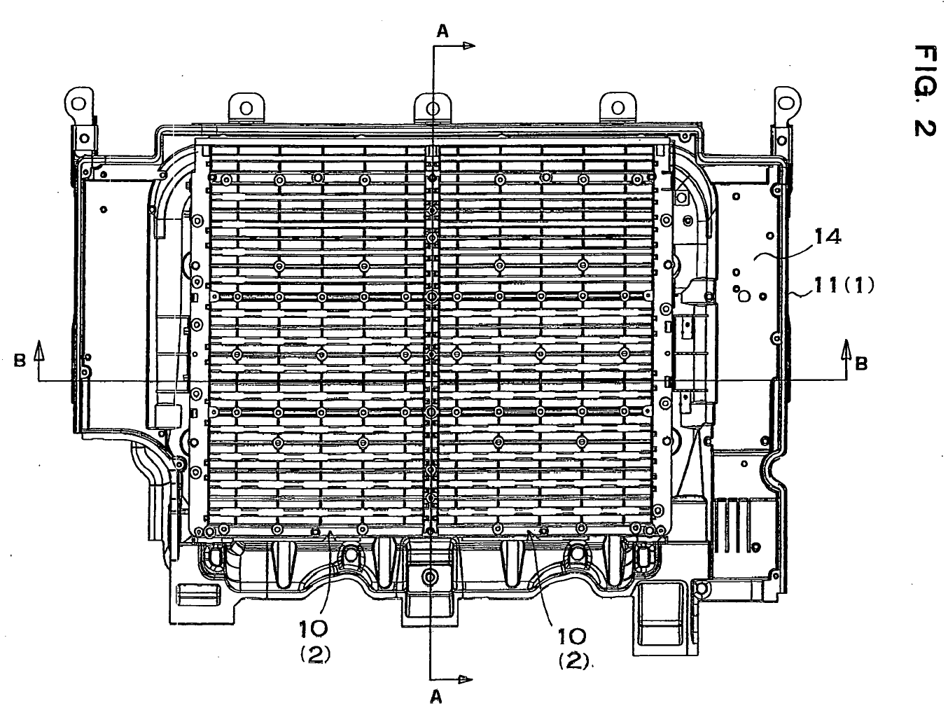

In a power device for a vehicle shown in FIGS. 2 to 7, a resin component 2 to be a holder case 10 is fixed onto a base portion 1 with a metal screw 3. The resin component 2 shown in the drawings is the holder case 10 formed of plastic which accommodates a plurality of battery modules therein (not shown). In the power device shown in the drawings, the holder case 10 is laminated as the resin component 2 in two stages and is fixed to the base portion 1. Each holder case 10 has an upper case 10A and a lower case 10B which interpose and hold the battery module from above and below. Accordingly, the resin component 2 is the holder case 10 laminated by a division into four portions. Each holder case 10 is integrally formed of plastic. The holder case 10 to be the resin component 2 is plastic reinforced by embedding a reinforcing fiber such as a glass fiber. The resin component can be formed of plastic which does not embed the reinforcing fiber. Moreover, the resin component is a thermosetting plastic or a thermoplastic, and can be formed by a resin having a sufficient strength for mounting on the vehicle.

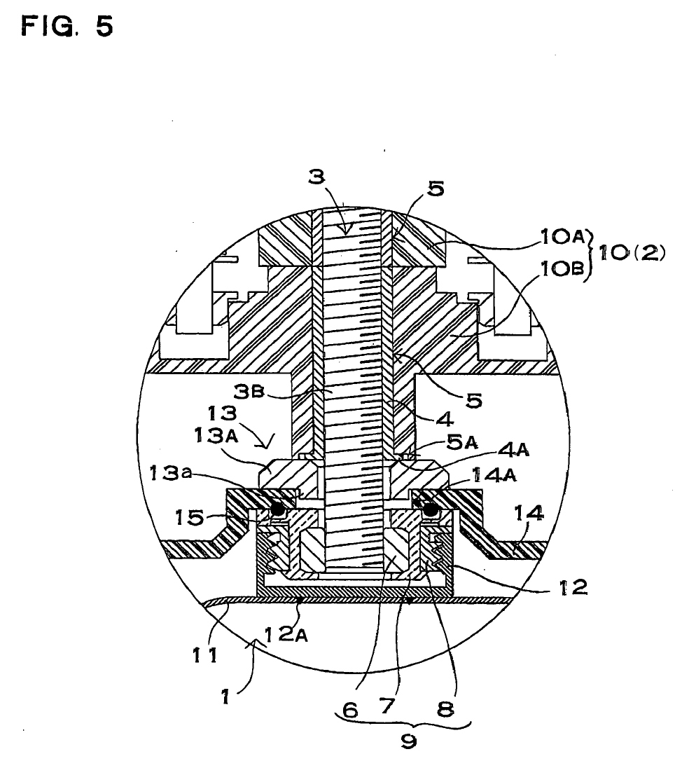

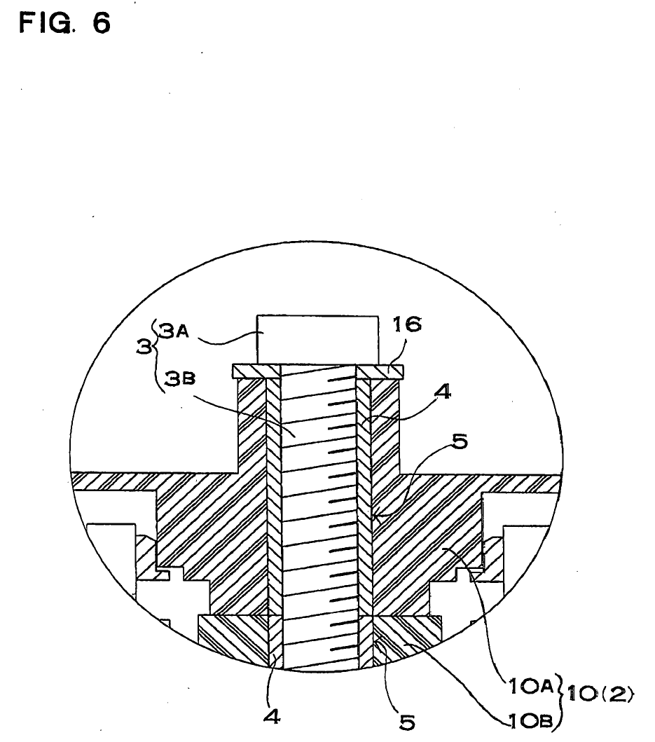

FIGS. 5 and 6 are enlarged sectional views showing a portion in which the metal screw 3 fixes the holder case 10 to be the resin component 2 to the base portion 1. FIG. 5 shows the lower end of the metal screw 3 and FIG. 6 shows the upper end of the metal screw 3. In the power device, a lower end to be a tip portion of the metal screw 3 is screwed into a female screw member 6 of the base portion 1 and the resin component 2 is thus fixed to the base portion 1 with the metal screw 3. The tip portion of the metal screw 3 is screwed into the female screw member 6 to fix the resin component 2 to the base portion 1 with a screw head 3A.

The power device shown in FIGS. 2 to 7 comprises the base portion 1 to be mounted on a vehicle, the resin component 2 having a through hole 5 to be fixed to the base portion 1, a metal sleeve 4 fixed to the internal surface of the through hole 5 of the resin component 2 and having a flange 4A on an opposed surface to the base portion 1, and the metal screw 3 inserted through the metal sleeve 4 fixed to the through hole 5 of the resin component 2 and securing the resin component 2 to the base portion 1 through the metal sleeve 4.

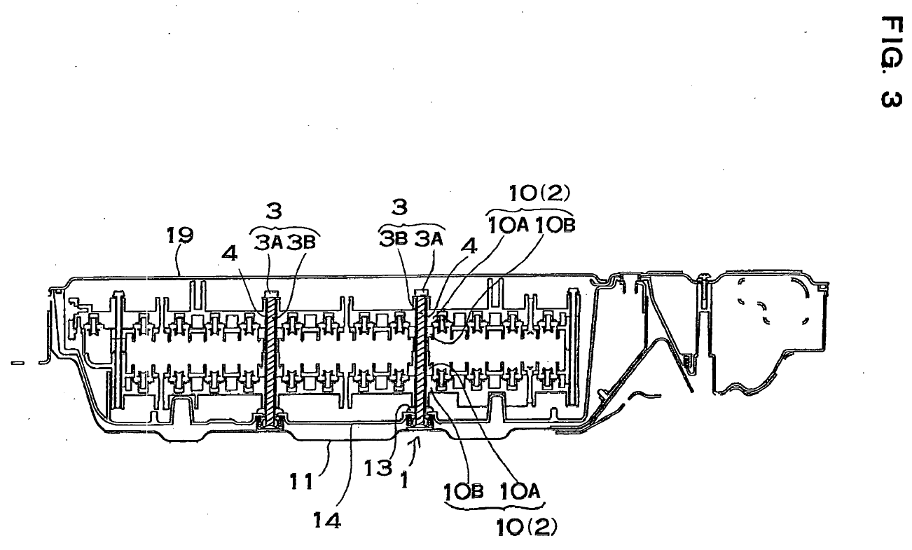

The base portion 1 shown in sectional views of FIGS. 3 and 5 is constituted by separate parts from a vehicle body and includes a base plate 11 to be fixed to a vehicle body. The base plate 11 can also be constituted by parts forming a part of the vehicle. The base plate 11 is a metal plate to be fixed to a chassis of the vehicle. The base portion 1 fixes the female screw member 6 to the base plate 11 through a rubber-like elastic member 7. Furthermore, the base portion 1 in FIG. 5 fixes a metallic outer casing 9 to the outside of the female screw member 6 through a rubber-like elastic member 7, thereby forming a rubber nut 9. The rubber nut 9 is screwed into a screw cylinder 12 fixed to the base plate 11 and is thus secured to the base portion 1. The screw cylinder 12 has a bottom closed, and the closed bottom face is welded and fixed to the surface of the base plate 1. The screw cylinder 12 in FIG. 5 has a convex portion 12A provided like a ring on a lower end, and the convex portion 12A is ring welded and is thus fixed to the upper surface of the base plate 11. With this structure, the screw cylinder 12 can be fixed to the base plate 11 firmly and strongly. The rubber nut 9 has a male screw provided on the outer periphery of the metallic outer casing B. The screw cylinder 12 has a female screw provided on an inner peripheral surface. The rubber nut 9 is screwed into the screw cylinder 12 and is coupled to the base plate 11 so that the female screw member 6 is coupled to the base plate 11 through the rubber-like elastic member 7.

With the aforementioned structure, the female screw member 6 to be coupled by screwing the metal screw 3 can be coupled to the base plate 11 firmly through the rubber-like elastic member 7. The rubber-like elastic member 7 is an insulating member. Accordingly, the metal screw 3 is insulated with the rubber-like elastic member 7 and can be firmly coupled to the metallic base plate 11. The metal sleeve 4 to come in contact with the metal screw 3 is also fixed firmly to the base plate 11 in an insulating condition. The reason is that the metal screw 3 with which the metal sleeve 4 comes in contact is insulated and is fixed to the base plate 11. In the power device in which the resin component 2 serves as the holder case 10, it is important that the metal screw 3 and the metal sleeve 4 are fixed to the base plate 11 in an insulating condition. The reason is as follows. Even if a battery accommodated in the holder case 10 comes in contact with the metal sleeve 4 or the metal screw 3, a current is not supplied to the chassis of the vehicle and a breakdown such as a short circuit can be prevented. Moreover, the structure in which the female screw member 6 is fixed to the base plate 11 through the rubber-like elastic member 7 also has a feature that the vibration of the base portion 1 can be absorbed into the rubber-like elastic member 7. The rubber-like elastic member 7 having a buffer action absorbs the vibration of the base portion 1, thereby preventing the metal screw 3 and the holder case 10 from being vibrated. Therefore, there is a feature that the vibrations of the holder case 10 and the battery module to be accommodated therein can be lessened even if the chassis of the vehicle is vibrated.

The base portion 1 has a support member 13 provided on an opposed surface to the metal sleeve 4. The reason is that the support member 13 is to abut on the flange 4A of the metal sleeve 4, thereby interposing and holding the metal sleeve 4 firmly. In the base portion 1 in FIG. 5, the support member 13 is constituted by a hard ring 13A. The hard ring 13A is formed of hard plastic which is not deformed at a pressure to fasten the metal screw 3, for example, engineering plastic such as a polyamide resin or a polyacetal resin. The hard ring 13A is fabricated by molding the plastic like a ring. The hard ring 13A can also be fabricated by processing a metal like a ring.

In the power device shown in FIG. 3, furthermore, the holder case 10 to be the resin component 2 is accommodated in an outer case 14 formed of plastic and is fixed onto the base portion 1. In the power device, the outer case 14 formed of plastic is fixed onto the base plate 11 to be a metal plate, and the holder case 10 is accommodated in the outer case 14. The outer case 14 is fixed to the base plate 11 with the metal screw 3 for fixing the holder case 10 to be the resin component 2. The structure in which the outer case 14 is fixed to the base plate 11 is shown in the sectional view of FIG. 5. With the fixing structure in FIG. 5, the outer case 14 is interposed between the hard ring 13A to be the support member 13 and the rubber nut 9 and is thus fixed to the base plate 11. The outer case 14 is provided with a coupling hole 14A for causing the metal screw 3 to penetrate through the coupling hole 14A. The coupling hole 14A has such a size as to insert a convex ring 13a provided to be protruded downward from the inner periphery of the hard ring 13A. With the coupling structure in FIG. 3, furthermore, an O ring 15 is interposed between the outer case 14 and the hard ring 13A. The O ring 15 couples the lower surface of the outer case 14 to the base portion 1 in a watertight structure. With this structure, accordingly, it is possible to reliably prevent water from entering the outer case 14 from the coupling portion to the base portion 1.

The metal sleeve 4 is fabricated by cylindrically processing a metal such as iron or an iron alloy and plating a surface with a metal such as chromium, tin or zinc. The metal sleeve can also be fabricated by any metal having a smaller thermal expansion than the resin component, for example, a metal such as stainless, brass, copper, a copper alloy, aluminum or an aluminum alloy.

The metal sleeve 4 has the flange 4A provided on the opposed surface to the base portion 1. In the holder case 10 to be the resin component 2, a concave portion 5A for putting the flange 4A therein is provided on the periphery of the through hole 5. While the metal sleeve 4 in the drawing has the flange 4A provided on only the opposed surface to the base portion 1, the flange can also be provided on an upper end held by the screw head 3A. The flange 4A uniformly comes in contact with the surface of the support member 13 in a large area. Therefore, the metal sleeve 4 having the flange 4A is pressed against the support member 13 at a uniform pressure and is fixed stably and firmly without a positional shift.

The metal sleeve 4 has such a thickness as not to be deformed in the fastening state of the metal screw 3. A fastening force is varied depending on the thickness of the screw portion 3B of the metal screw 3. Accordingly, the thickness of the metal sleeve 4 is also varied depending on the thickness of the screw portion 3B to be inserted therein. The thickness is increased when the screw portion is thickened so that the inside diameter of the metal sleeve 4 is increased, and is reduced when the screw portion is thinned so that the inside diameter of the metal sleeve 4 is reduced. Moreover, the strength of the metal sleeve 4 is varied depending on a material. For this reason, an optimum thickness is set in consideration of the material. For example, the metal sleeve 4 formed of iron is set to have a thickness of 1 to 4 mm. The metal sleeve is thickened to have a tough structure even if a length is increased. Although the metal sleeve 4 takes the cylindrical shape, it does not need to take the cylindrical shape but can also take the shape of a polygonal cylinder, for example.

The metal sleeve 4 is pressed into the through hole 5 of the resin component 2 and is thus fixed to the resin component 2. With this structure, the metal sleeve 4 can easily be fixed to the resin component 2. The metal sleeve 4 has an external shape which is slightly larger than the internal shape of the through hole 5 of the resin component 2. In other words, the external shape of the metal sleeve 4 is thicker than the internal shape of the through hole 5. The metal sleeve 4 is firmly pressed into the resin component 2. The reason is that the internal surface of the through hole 5 is fixed to the surface of the metal sleeve 4 in a pressing state. The metal sleeve 4 can also be pressed into the through hole 5 via a bonding member and thus fixed firmly. Moreover, the metal sleeve can also be inserted and fixed when the plastic of the resin component is to be molded. The metal sleeve is temporarily fastened to a metal mold for molding the resin component by plastic and is inserted and fixed to the plastic to form the resin component. The metal sleeve to be inserted and fixed into the resin component has concavo-convex portions provided on a surface at an outside and is fixed to the resin component so as not to slip off.

Since the metal sleeve 4 fixed to the resin component 2 has an integral structure with the resin component 2, it can be assembled conveniently. However, the metal sleeve 4 does not need to be fixed to the resin component 2. The reason is that both the metal sleeve 4 and the resin component 2 are interposed between and fixed to both ends and the resin component 2 can be thus fixed to the base portion 1 as shown in FIG. 3. The resin component 2 shown in these drawings has such a structure that the metal sleeve 4 can be set to have the length of the through hole 5 and can be held with the metal screw 3. With this structure, it is possible to fix the resin component 2 to the base portion 1 while preventing the looseness of the metal screw 3 by means of the metal sleeve 4.

Ideally, the metal sleeve 4 is set to have a length which is equal to that of the through hole 5 and is fixed by pressing, bonding and insertion into the resin component 2, and the like as shown in FIGS. 5 and 6. With this structure, both the resin component 2 and the metal sleeve 4 are interposed between and fixed to the metal screw 3 and the base portion 1, and furthermore, are secured to the resin component 2 through the metal sleeve 4. According to this structure, the resin component 2 can he fixed to the base portion 1 in an ideal condition. The reason is as follows. Even if the resin component 2 repeats a thermal expansion and a thermal contraction so that a clearance is formed between the metal screw 3 and the base portion 1 or the resin component 2 cannot be interposed and fixed in a sufficient strength between the metal screw 3 and the base portion 1, the metal screw 3 firmly holds the metal sleeve 4 to be fixed to the base portion 1 and secures the resin component 2 to the base portion 1 through the metal sleeve 4.

The metal screw 3 in FIG. 6 presses and fixes the metal sleeve 4 and the resin component 2 with the screw head 3A on a rear end. The metal screw 3 rotates the screw head 3A on the rear end to screw a male screw on the tip of the screw portion 3B into the female screw member 6, and is thus fixed to the base portion 1. However, the metal screw does not need to have the structure in which the screw head is provided. For example, it is also possible to provide a male screw on both ends and to screw a nut into the male screw on the rear end, thereby holding the metal sleeve, which is not shown. In the metal screw, the male screw on a tip is screwed into the female screw member to be coupled to the base portion, and the nut is then screwed into the male screw on the rear end so that the resin component can be fixed to the base portion. Moreover, it is also possible to screw the male screw on the tip into the female screw member, thereby fixing the resin component to the base portion in a state in which the nut is screwed into the male screw on the rear end.

The metal screw 3 in FIG. 6 holds the metal sleeve 4 through a washer 16. The washer 16 is a metallic flat washer. The external shape of the washer 16 is larger than the screw head 3A, and the flat washer 16 presses the surfaces of the metal sleeve 4 and the resin component 2 and fixes them to the base portion 1.

With the coupling structure described above, the support member 13 is set to be the hard ring 13A, and the outer case 14 is interposed between the hard ring 13A and the rubber nut 9 and is thus fixed. In the power device according to the present invention, however, it is possible to superpose the hard ring of the support member on the rubber nut and to cause the metal sleeve to abut on the hard ring, thereby fixing the holder case to be the resin component to the base portion without holding the outer case. In the power device according to the present invention, moreover, it is also possible to fix the resin component to the base portion without using the rubber nut. With the coupling structure, the female screw hole is provided on the base plate to be the metal plate to form the female screw member, and the base plate is set to be the support member. The metal screw is screwed into the female screw hole so that the metal sleeve is interposed between the screw head of the metal screw and the base plate of the support member and is thus fixed. In addition, it is also possible to fix the metal nut to the base portion and to constitute the female screw member and the support member by the metal nut, and to screw the metal screw into the metal nut, thereby fixing the resin component to the base portion.

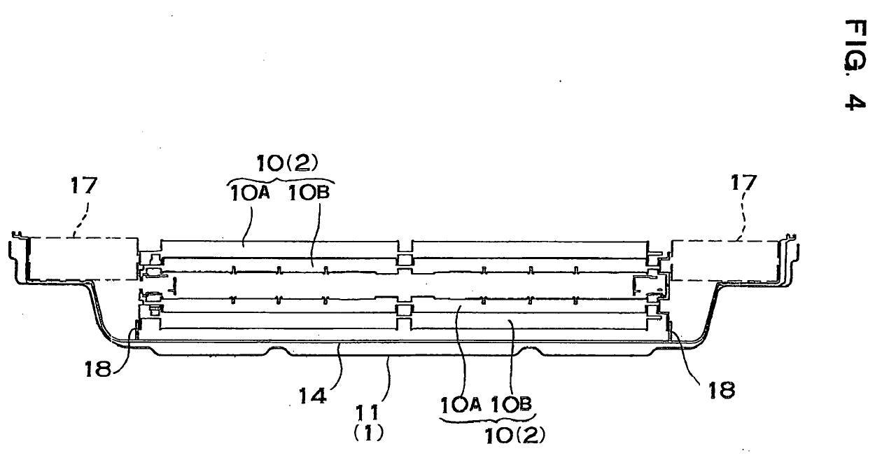

FIG. 4 is a lateral end view showing the power device illustrated in FIG. 2. In the power device shown in FIG. 4, the outer case 14 is fixed onto the base plate 11, and the holder case 10 is accommodated in the outer case 14. The outer case 14 includes an electronic circuit 17 for controlling the charge/discharge of a battery as shown in a chain line of FIG. 4 and the like as well as the holder case 10. In the outer case 14 in FIG. 4, the side portion of the holder case 10 has a space for providing the electronic circuit 17 therein. In the outer case 14 having this structure, the holder case 10 to be the resin component 2 is set into a predetermined position and is fixed to the base plate 11 of the base portion 1 with the metal screw 3. Then, the predetermined position of the holder case 10 is coupled with a screw. Thereafter, the upper opening portion of the outer case 14 is closed with an upper cover 19. When these works are carried out, the screw might drop into the outer case 14 by mistake. The screw might enter a portion between the lower surface of the holder case 10 and the outer case 14. The screw entering this portion can be taken out with difficulty. After the holder case 10 is fixed to the outer case 14 with the metal screw 3, it is particularly hard to take the screw out. However, the screw entering this portion comes in contact with a metal portion, thereby causing a short circuit, and furthermore, is vibrated to make a noise. For this reason, it is necessary to reliably take the screw out.

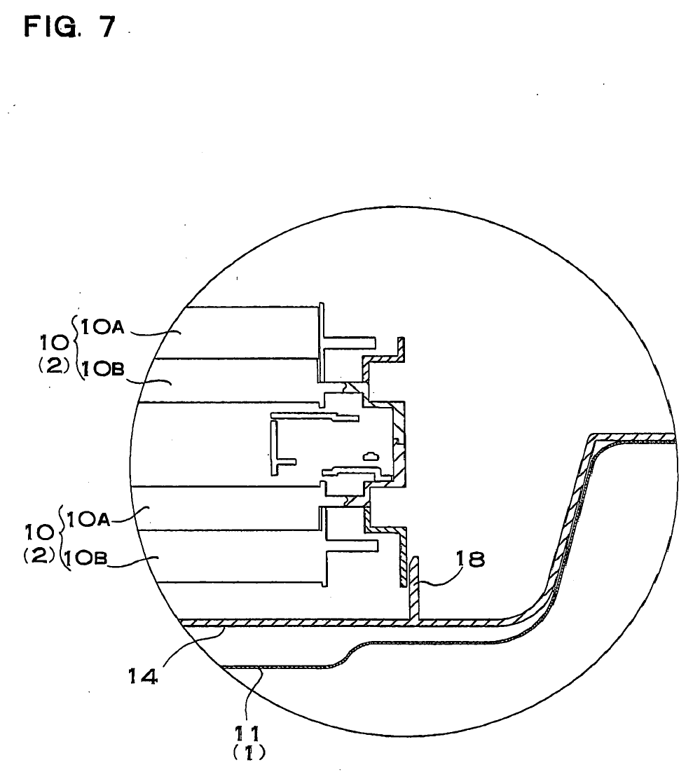

In order to eliminate the bad effect, the outer case 14 shown in FIGS. 4 and 7 is provided with a foreign matter invasion blocking wall 18 which is protruded from the internal surface of the outer case 14, and the holder case 10 is accommodated in the foreign matter invasion blocking wall 18. The foreign matter invasion blocking wall 18 approaches the outside surface of the holder case 10 to be the resin component 2, thereby preventing a foreign matter from entering a portion formed together with the holder case 10 as shown in an enlarged end view of FIG. 7. With this structure, even if a foreign matter such as a screw drops into the space for mounting the electronic circuit 17, it is possible to prevent the foreign matter from entering a portion provided under the holder case 10 in which the foreign matter is taken out with difficulty. Even if the screw or the like drops into the outer case 14 by mistake, therefore, it can easily be taken out.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims, This application is based on Application No. 2004-215,309 filed in Japan on Jul. 23, 2004, the content of which is incorporated hereinto by reference.

What is claimed is:

1. A power device for a vehicle comprising:
a base portion to be mounted on the vehicle;
a resin component having a through hole which is to be fixed to the base portion;
a metal sleeve inserted through an internal surface of the through hole of the resin component and having a flange on an opposed surface to the base portion; and
a metal screw inserted through the metal sleeve inserted in the through hole of the resin component, thereby fixing the resin component to the base portion through the metal sleeve,
wherein the base portion has a female screw member into which a tip portion of the metal screw 3 is to be screwed and has a support member provided on an opposed surface to the metal sleeve, and
the metal screw is inserted through the metal sleeve to screw a screw portion on a tip into the female screw member and fixes the metal sleeve to the base portion, thereby securing the resin component to the base portion.

2. The power device for a vehicle according to claim 1, wherein the base portion includes the female screw member and a base plate fixing the female screw member, and the female screw member is secured to the base plate through a rubber-like elastic member.

3. The power device for a vehicle according to claim 2, wherein the base portion includes a rubber nut fixing a metallic outer casing to an outside of the female screw member through the rubber-like elastic member, and a screw cylinder fixed to the base plate to secure the rubber nut, and
the rubber nut has a male screw provided on an outer periphery of the metallic outer casing, the screw cylinder has a female screw provided on an inner peripheral surface, and the male screw of the rubber nut is screwed into the female screw of the screw cylinder, thereby coupling the rubber nut to the base plate.

4. The power device for a vehicle according to claim 3, wherein the screw cylinder is fixed to the base plate by ring welding.

5. The power device for a vehicle according to claim 3, wherein the rubber-like elastic member of the rubber nut is an insulating member, and the metal screw is insulated with the rubber-like elastic member and is coupled to the base plate formed of a metal.

6. The power device for a vehicle according to claim 1, wherein the resin component is a holder case for a battery which accommodates a plurality of batteries therein.

7. The power device for a vehicle according to claim 1, wherein an overall length of the metal sleeve is almost equal to a length of the through hole having the metal sleeve provided therein, and the metal screw holds both the metal sleeve and the resin component and fixes them to the base portion.

8. The power device for a vehicle according to claim 1, wherein a hard ring to be the support member is provided between the metal sleeve and the base portion and is caused to abut on the flange.

9. The power device for a vehicle according to claim 8, wherein the support member is formed of hard plastic.

10. The power device for a vehicle according to claim 1, wherein the support member is a metal ring.

11. The power device for a vehicle according to claim 1, wherein the metal sleeve is formed of any of iron, an iron alloy, stainless, brass, copper, a copper alloy, aluminum and an aluminum alloy.

12. The power device for a vehicle according to claim 1, wherein the metal sleeve is pressed into the through hole of the resin component and is thus fixed to the resin component.

13. The power device for a vehicle according to claim 1, wherein the metal sleeve is inserted and fixed into the resin component formed of plastic.

14. The power device for a vehicle according to claim 6, wherein the holder case to be the resin component is accommodated in the outer case.

15. The power device for a vehicle according to claim 3, wherein the holder case to be the resin component is accommodated in the outer case, and the outer case is interposed between a hard ring and the rubber nut and is fixed to the base portion.

16. The power device for a vehicle according to claim 15, wherein a foreign matter invasion blocking wall is protruded from an internal surface of the outer case, and the holder case is accommodated in the foreign matter invasion blocking wall to prevent an invasion of a foreign matter by means of the foreign matter invasion blocking wall.

17. The power device for a vehicle according to claim 1, wherein the metal screw presses and fixes the metal sleeve and the resin component by means of a screw head provided on a rear end.
